(19) United States
(12) Patent Application Publication
(10) Pub. No.: US 2021/0016673 A1
(43) Pub. Date: Jan. 21, 2021

(54) Scooter Racking or Docking System and Related Methods

(71) Applicant: David Howorka, Rancho Santa Fe, CA (US)

(72) Inventor: David Howorka, Rancho Santa Fe, CA (US)

(21) Appl. No.: 16/866,092

(22) Filed: May 4, 2020

Related U.S. Application Data
(60) Provisional application No. 62/843,168, filed on May 3, 2019.

(51) Int. Cl. B60L 53/30; B62H 3/10; B60L 53/51

(52) U.S. Cl. CPC B60L 53/30; B60L 53/51; B62H 3/10

(57) ABSTRACT

Disclosed is a scooter rack that is capable of retaining scooters in a designated and consolidated location. In some embodiments, the disclosed scooter rack features a charging mechanism for charging the battery of an e-scooter. In other embodiments, the rack features a billboard for posting directions, warnings, or advertisements.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of vehicle racking and/or docking systems.

### Background of the Invention

According to the California Vehicle Code (CVC) § 407.5 a “motorized scooter” is any two-wheeled device that has handlebars, a floorboard that is designed to be stood upon when riding and is powered by a motor. “e-scooters” are a subclass of “motorized scooters” that have electric motors. Recently, e-scooters branded by BIRD® and LIME® (and other brands) have been outfitted with GPS tracking so that any person with a mobile device and like-branded software application can pay-to-ride to the e-scooters wherever they are found. The user may discontinue the ride by leaving the e-scooter on the spot of a completed trip.

Pay-to-ride e-scooters have become quite prolific in a short amount of time. There is no real solution for how to handle e-scooters that are left in areas where they are unwelcome—and particularly on private property or city sidewalks and streets. The business owners and city workers struggle with how to handle the e-scooter influx as many embrace the environmental benefits of eliminating car travel for short trips; but many declare a nuisance when scooters are not parked properly. The scooters sometimes interfere with local business operations, parking, handicap access and in many cases cause premises hazards. In most cases, there is no way to contact the pay-to-ride e-scooter owners to move the scooter causing business owners and cities to expend resources monitoring and constantly moving scooters back and forth. The process of removing the unwanted scooters is labor intensive and expensive.

Pay-to-ride e-scooter owners also have an issue with e-scooters being left to-and-fro by the riders because the owners must gather the e-scooters so that the batteries of the e-scooter's electric motors can be charged daily. Gathering the scooters requires a team of “chargers” that pick-up the scooters for overnight recharge. This process is not only tedious, but often the “chargers” damage the scooters during pickup.

Different strategies for dealing with the influx of e-scooters have been proposed. For instance, some cities have painted corals or designated e-scooter parking along the roadside. But, this solution is not totally satisfactory because e-scooters are susceptible to falling over or being knocked over, and they cannot be charged, which requires chargers to pick them up.

### SUMMARY OF THE INVENTION

In view of the foregoing, an object of this specification is to disclose a scooter rack that is capable of retaining scooters in a designated and consolidated location. It is further an object of the invention to provide a charging mechanism so that scooters can be charged while retained within the scooter rack.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a front perspective view of an e-scooter rack 1000;

FIG. 2 is a rear perspective view of the e-scooter rack 1000;

FIG. 3 is a side view of the e-scooter rack 1000;

FIG. 4 is a top view of the e-scooter rack 1000;

FIG. 5 is a bottom view of the e-scooter rack 1000;

FIG. 6 is a front perspective view of an e-scooter rack 1000 with two e-scooters 2000 docked there;

FIG. 7 is a rear perspective view of the e-scooter rack 1000 with two e-scooters 2000 docked there;

FIG. 8 is a side view of the e-scooter rack 1000 with two e-scooters 2000 docked there;

FIG. 9 is a top view of the e-scooter rack 1000 with two e-scooters 2000 docked there;

FIG. 10 is a bottom view of the e-scooter rack 1000 with two e-scooters 2000 docked there;

FIG. 11 a front perspective view of an e-scooter rack 1000 with a with two e-scooters 2000 docked there and a battery charger 3000 positioned underneath the dock 1500 of the rack 1000;

FIG. 12 is a front perspective view of an e-scooter rack 1000 with a with two e-scooters 2000 docked there and a billboard 5000; and,

FIG. 13 is a front perspective view of an e-scooter rack 1000 with a with two e-scooters 2000 docked there, a solar panel 4000 positioned on a first mast 1100 of the rack 1000, an inverter 4100, charger 4200, and battery cell 4300 coupled to the solar panel 4000, and a battery charger 3000 or the e-scooters 2000 positioned underneath the dock 1500 of the rack 1000.

In the drawings, the following reference numerals represent the associated components:
1000—rack
   1100—dock
      1110—e-scooter slip
   1200—first base
      1210—first mast
   1300—second base
      1310—second mast
   1400—cross bar
2000—e-scooter
3000—battery charger
4000 solar panel
   4100—inverter
   4200—charger
   4300—battery cell
5000—billboard.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a scooter rack that is capable of retaining scooters in a designated and consolidated location. In some embodiments, the disclosed scooter rack features a charging mechanism for charging the battery of an e-scooter. In other embodiments, the rack features a billboard for posting directions, warnings, or advertisements. The more specific details of the disclosed scooter rack are described with reference to the appended figures.

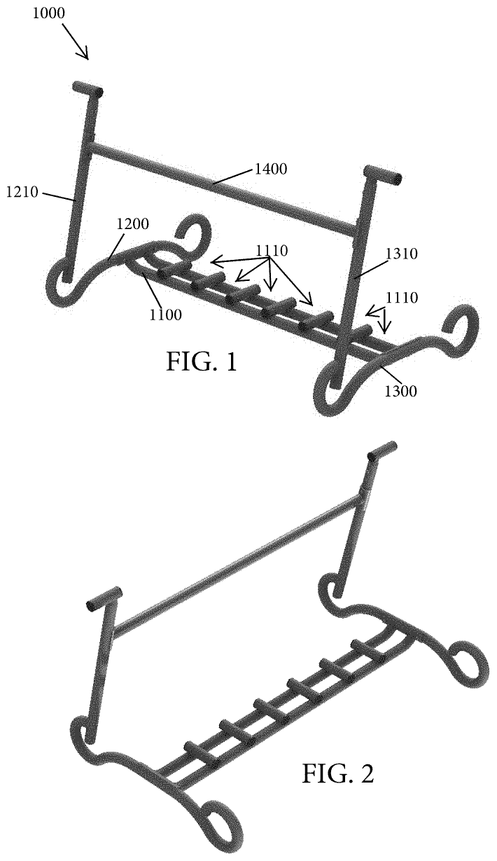

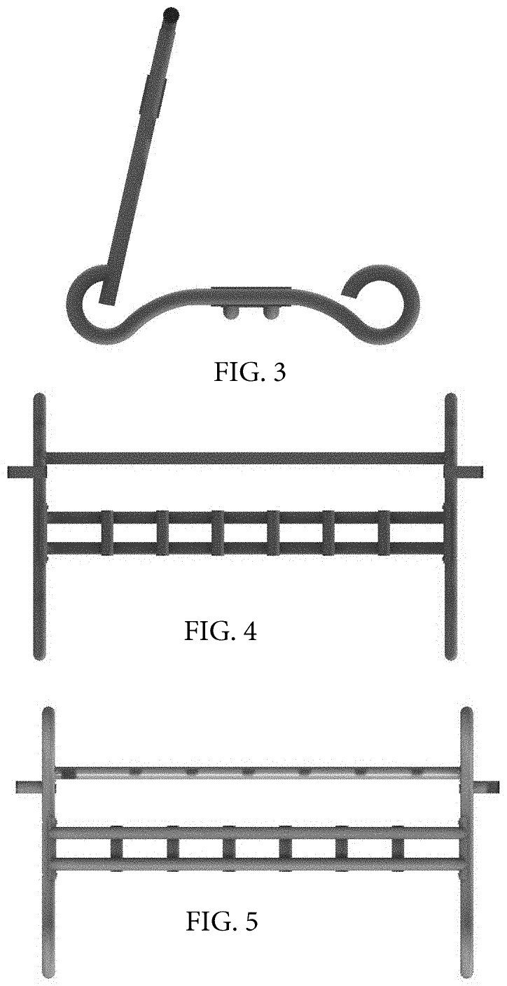

FIG. 1 is a front perspective view of an e-scooter rack 1000. FIG. 2 is a rear perspective view of the e-scooter rack 1000. FIG. 3 is a side view of the e-scooter rack 1000. FIG. 4 is a top view of the e-scooter rack 1000. FIG. 5 is a bottom view of the e-scooter rack 1000. As shown in FIGS. 1 through 5, the scooter rack 1000 is generally defined by: (1) a dock 1100 with a plurality of e-scooter slips 1110; (2) where the dock 1100 is suspended between a first and second base 1200,1300 so an e-scooter (not shown in FIGS. 1 through 5) may be placed within a slip 1110 and be held in place within the dock 1100; and (3) a first and second mast 1210, 1310 respectively positioned upright from the first and second base 1200, 1300 and suspending a cross bar 1400 to which a scooter (not shown in FIGS. 1 through 5) may optionally be tethered. Preferably, the first base 1200 and its associated mast 1210 may be provided in the silhouette of a scooter. Similarly preferable, the second base 1300 and its associated mast 1310 may be provided in the silhouette of a scooter.

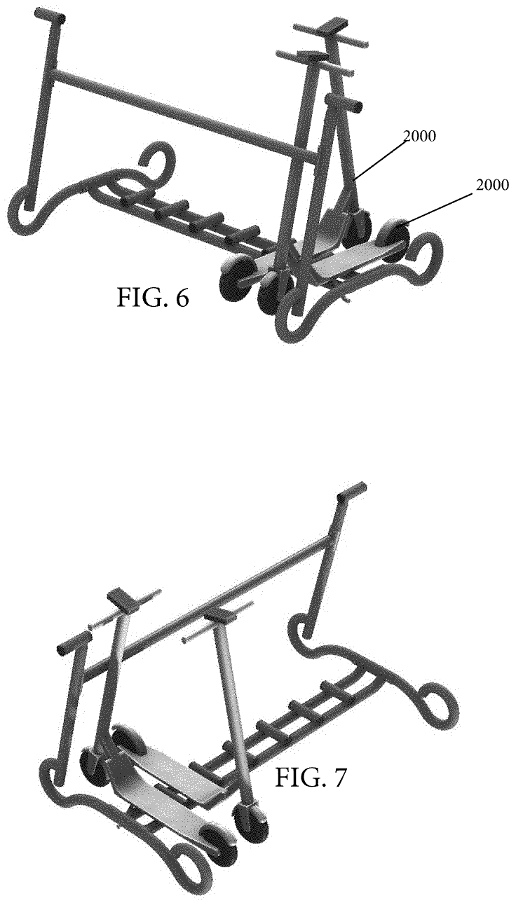

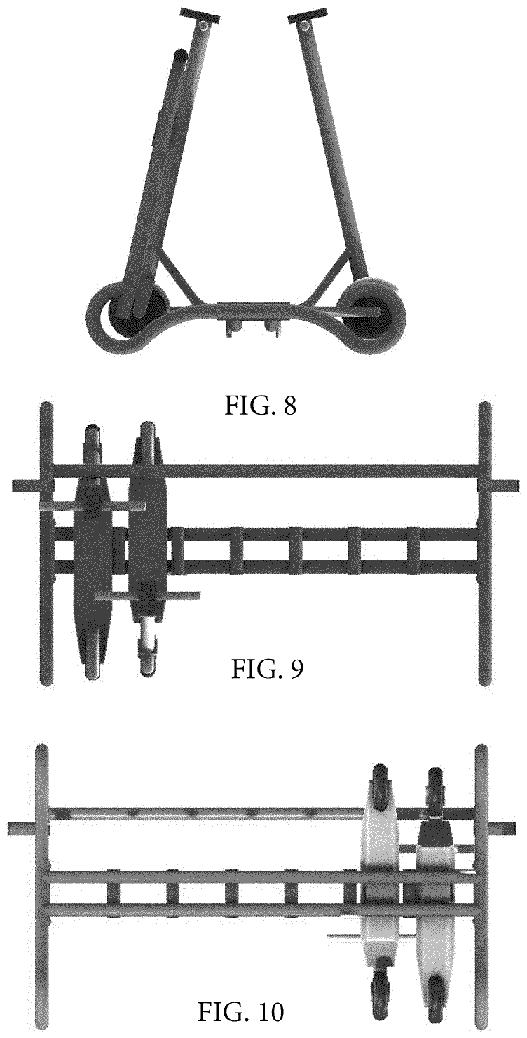

FIG. 6 is a front perspective view of an e-scooter rack 1000 with two e-scooters 2000 docked there. FIG. 7 is a rear perspective view of the e-scooter rack 1000 with two e-scooters 2000 docked there. FIG. 8 is a side view of the e-scooter rack 1000 with two e-scooters 2000 docked there. FIG. 9 is a top view of the e-scooter rack 1000 with two e-scooters 2000 docked there. FIG. 10 is a bottom view of the e-scooter rack 1000 with two e-scooters 2000 docked there.

Referring to FIGS. 6 through 10, an e-scooter 2000 may suitably be placed in a the dock 1100 of the rack 1000 as shown by placing the scooter's base board into a slip 1110. In one mode of use, the scooter may be positioned with the handlebars adjacent to the cross bar 1400 of the rack 1000 so that the handlebars of the scooter may be tethered to the rack 1000. In alternate mode of use, the scooter 2000 may be positioned with the handlebars away from the crossbar 1400 of the rack for easy access by a user.

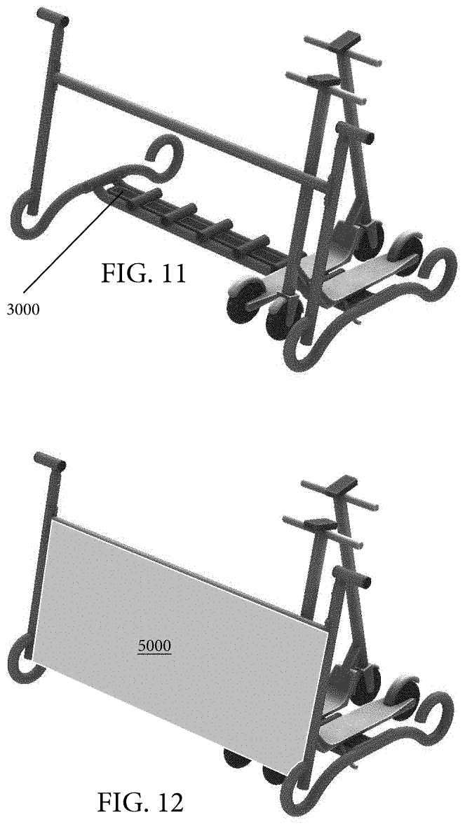

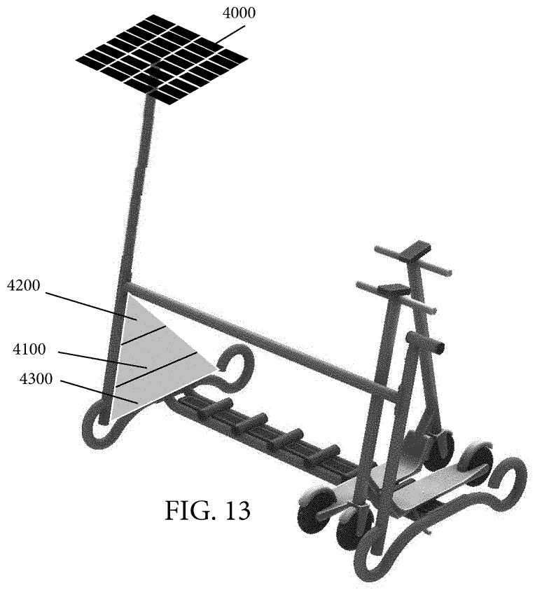

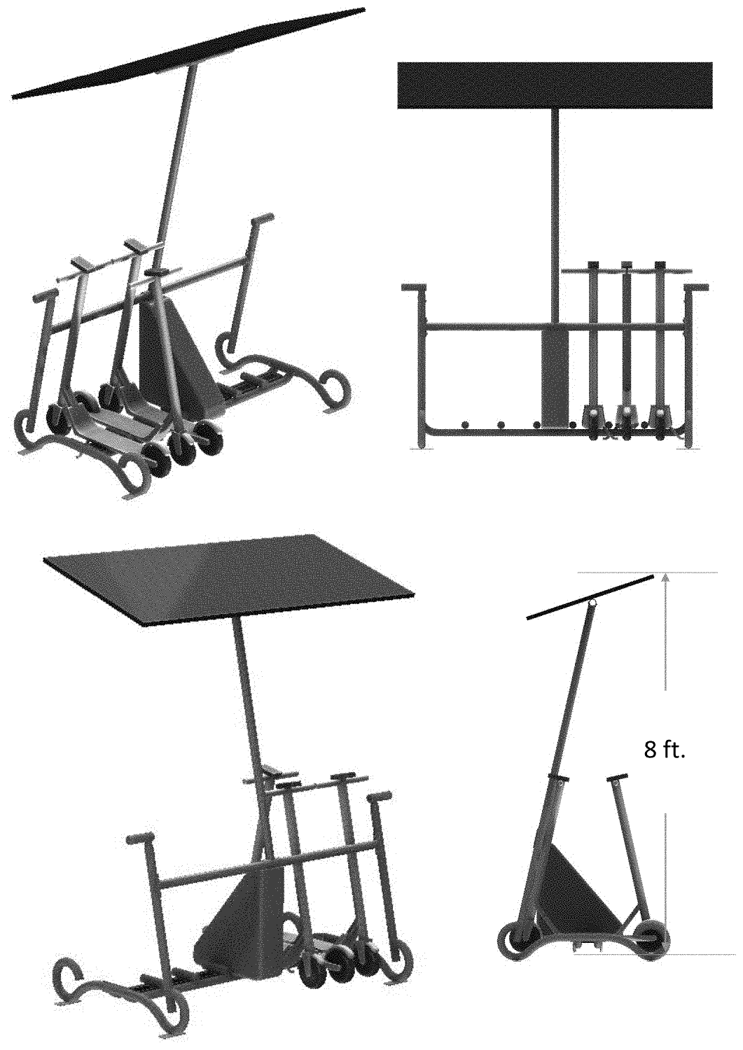

FIG. 11 a front perspective view of an e-scooter rack 1000 with a with two e-scooters 2000 docked there and a battery charger 3000 positioned underneath the dock 1500 of the rack 1000. In a preferred embodiment, the battery charger is a wireless charger configured to provide electric charge the battery of a scooter 2000 positioned in a slip 1110 so that the scooter's battery is electrically connected to the charger 3000. Suitably, the charger 3000 may be battery powered (not shown) or solar powered. A solar powered version is shown in FIG. 13. More specifically, FIG. 13 is a front perspective view of an e-scooter rack 1000 with a with two e-scooters 2000 docked there, a solar panel 4000 positioned on a first mast 1100 of the rack 1000, an inverter 4100, charger 4200, and battery cell 4300 coupled to the solar panel 4000, and a battery charger 3000 or the e-scooters 2000 positioned underneath the dock 1500 of the rack 1000.

FIG. 12 is a front perspective view of an e-scooter rack 1000 with a with two e-scooters 2000 docked there and a billboard 5000. Suitably the billboard may display information. In one embodiment the billboard displays directions for docking an e-scooter in the dock. In another embodiment, the billboard may display and advertisement or artwork. As shown, the billboard 5000 may be coupled to the uprights 1200, 1300 and crossbar 1400 of the rack 1000

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A scooter rack with a dock for e-scooters.

2. The scooter rack of claim 1 with a charging mechanism for charging a battery of the e-scooters.

3. The scooter rack of claim 2 where the charging mechanism includes a solar panel.
